(19) United States
(12) Patent Application Publication
(10) Pub. No.: US 2011/0176424 A1
(43) Pub. Date: Jul. 21, 2011

(54) LOAD BALANCING IN A MOBILE COMMUNICATIONS SYSTEM

(76) Inventors: Xuejun Yang, Jarfalla (CH); Henrik Olofsson, Kista (CH); Michael Roberts, Kista (CH)

(21) Appl. No.: 12/966,745

(22) Filed: Dec. 13, 2010

Related U.S. Application Data
(63) Continuation of application No. PCT/CN2008/071284, filed on Jun. 13, 2008.

(51) Int. Cl. H04W 28/08; H04W 28/02; H04W 72/10

(52) U.S. Cl. 370/236.2; 370/235; 370/236

(57) ABSTRACT

Load balancing in a mobile communications system comprising dynamically setting of a representation of a mapping table for mapping data to a respective UE priority list of two or more access layers is disclosed. In accordance with example embodiments, UE and/or network capabilities are input to the setting.

This application is a continuation of PCT international application No. PCT/CN2008/071284, filed on Jun. 13, 2008.

### TECHNICAL FIELD

The present invention pertains to load balancing in a mobile communications system. Example embodiments pertain to a mobile communications system comprising a plurality of access layers and mapping of a Classifier Index to a priority order list for the plurality of access layers.

### BACKGROUND

In a typical cellular wireless system, a User Equipment (UE) shall regularly search for a better cell to camp on according to cell reselection criterion. The purpose of this mechanism is to ensure an acceptable quality of camping cell and therefore to achieve the desired cell setup performance. As the UE is roaming in the network, cell reselection to a new cell may trigger a subsequent mobility management procedure, location update.

Cell reselection criterion is based on parameters provided by the network. The network set the parameters to imply either a reactive cell reselection which causes a large cost on UE battery, or a too rare cell reselection, which is not able to ensure that bad cell quality of a camping cell is minimized or even avoided.

In 3rd Generation Partnership Project (3GPP), cell reselection based on priority criterion is introduced in Release 8 specification for inter-frequency/inter-Radio Access Technology (RAT) case where each UE shall cell reselect to a cell in a frequency/RAT layer based on a priority list. This is referred to as priority-based cell reselection.

The priority list that the UE uses for cell reselection could be a dedicated one if available; otherwise it uses a common priority list signaled through a broadcast channel.

When the UE is not on its highest priority layer, it always searches higher priority layers and reselects to the highest layer once it fulfills the signal threshold requirement. Under the condition that no higher priority layer is available or meets the signal threshold requirement, the UE may reselect to an equal or lower priority layer when the reception of the serving cell is not enough to ensure the quality of camping any longer. Of course, the equal or lower priority layer needs to meet the threshold requirement as well.

In 3GPP, a self-organized network feature has been discussed recently in an effort to minimize operational cost. One of the important aspects is that the system operability is improved in a multi-vendor environment. It is of importance that measurements and performance data of different vendors share the same “language.” Such alignment is easing network performance analyses and problem finding, and reduces efforts in maintaining the network at a properly working state.

Mobility load balancing optimization is one of agreed use cases. The objective of this use case is to optimize cell reselection/handover parameters to cope with the unequal traffic load and minimize number of handovers and redirections needed to achieve the load balancing.

### SUMMARY

It is identified that in prior art technology, the mapping table does not take into account or support network or UE capabilities. A simple example illustrates the advantage of taking this into consideration: There is no use pushing a UE device to RAT/Frequency layer where service requested by the UE device is not provided at all.

According to a preferred embodiment of the invention, network capability is taken into account in a mapping table.

Furthermore, according to an aspect of the invention, the mapping table is based on operator policy and network deployment configurations. Network deployment configuration is used, e.g., to derive network capability. Based on such facts, operator policy determines how to distribute the service to different RAT/Frequency layers. Accordingly, an example embodiment of the invention provides a method of priority control in inter-frequency and inter-RAT cell reselection, wherein:

a priority list is obtained by looking up a mapping table with an index subscriber profile identification and UE capability, and/or

the mapping table is built up based on operator policy of service distribution and network deployment configuration.

The mapping table is preferably updated for load balancing purpose with consideration of a set of load-related load performance indicators, such as load, number of idle mode UE, number of redirection etc.

An example implementation of the invention is by a computer program, provided as a computer program product, including code means, which when run in a computer causes the computer to execute the above mentioned method.

Further, according to an example embodiment of the invention, the mapping table is updated by altering at least one entry in relation to at least one load related performance indicator of the mobile communications system. This provides a flexible way to further balance the load of various layers in a dynamically changing environment. An example load related performance indicator is load information from any access network/access technology in the mobile communications system, such as from GSM EDGE Radio Access Network (GERAN), Universal Terrestrial Radio Access Network (UTRAN), or E-UTRAN (Evolved UTRAN). This load information is preferably evaluated on the granularity of cell or tracking area. Non-exclusive examples of other load related cell-specific performance indicators are:
number of redirects to or from a radio access network,
number of idle mode UEs in a radio access network,
number of periodic Traffic Area Updates (TAU) and load statistics in terms of Classifier Index.

The abovementioned performance indicators may all be useful in detecting an unbalanced situation of the mobile communications system.

Further, a specific example way to make use of a performance indicator is to set a mapping table update policy. For instance, the priority of an access layer is set to the lowest of an ordered priority list when load of the access layer is above a threshold.

Other example policies are:
setting of the priority of an access layer one level up in a priority order list when number of redirections to the layer is above a threshold,
setting of the priority of an access layer one level up in a priority order list when number of redirections to the layer is above a threshold, and
setting of the priority of an access layer one level up in a priority order list when number of idle UEs camping on the access layer is above a threshold.

In the case there is a risk that policies collide, a mapping table update policy is preferably prioritized such that when two or more policies are true only the one with highest priority is performed.

Further aspects and advantages of the invention are disclosed in the detailed description.

### BRIEF DESCRIPTION OF THE DRAWINGS

Embodiments exemplifying the invention will now be described, by means of the appended drawings, on which

FIG. 1 illustrates a priority look-up table,

FIG. 2 illustrates initial mapping table build-up,

FIG. 3 illustrates table ID configuration,

FIG. 4 illustrates table ID configuration,

FIG. 5 illustrates mapping table update, and

FIG. 6 illustrates a flowchart of a method of the invention.

### DETAILED DESCRIPTION

Self-optimization of cell reselection parameter to the current load in the cell and in the adjacent cell allows for UEs camping on a cell/layer where the network can ensure that the UEs are optimally serviced by the network. In an ideal case, the cell reselection parameters are set such that idle mode and active mode behaviour are consistent, and such that the number of handovers in active mode or redirection during transition from idle to active mode can be minimized.

Currently, the solution is based on the assumption that evolved Node B (eNB) monitors the load in the controlled cell and exchanges the related information over X2 with node(s) hosting the functionality of the algorithm of load balancing. This is mainly for intra-frequency case within Long Term Evolution (LTE) where X2 is available, while for inter-RAT cell reselection, cell load over X2 interface is most likely inapplicable and hence the solution is still a question.

As mentioned above, priority-based cell reselection is introduced in inter-frequency/inter-RAT case. Load of different frequency/RAT layers can be balanced through appropriately assigning dedicated priority list to UEs with consideration of traffic load of layers. The mobility load balancing optimization algorithm shall try to distribute UEs to the lowest load layer among those that are able to service the UEs, i.e. set the layer with the highest load to be the lowest priority of UEs and the layer with the lowest load to be the highest priority.

A problem in the prior art is how to perform priority control for inter-RAT and/or inter-frequency cell reselection for load balancing purpose. More specifically, how to assign priority list for a UE by taking load of different RAT/Frequency layers into account.

In Huawei, Telecom Italia (co-signer): ‘Mobility Load Balancing Optimization Use Case,’ R3-080525, 3GPP TSG RAN WG3 Meeting #59, Feb. 11-15, 2008, incorporated herein by reference, inventor discloses eNB monitoring load in a controlled cell and exchanging related information over an X2 interface between nodes, where the information is exchanged with one or more nodes where a load balancing action or status, such as (need of) load distribution, is determined.

In Huawei: ‘Idle mode Inter RAT load balancing,’ R3-8080757, 3GPP TSG RAN WG3 Meeting #59 bis, Mar. 31-Apr. 3, 2008, incorporated herein by reference, inventor discloses a priority control solution for idle-mode inter-RAT (Radio Access Technology) load balancing, where a centralized Self Organizing Network (SON) entity configures and subsequently updates a mapping table from a subscriber profile identity (also known as a RAT/Frequency Selection Priority (RFSP)) to a priority list of radio access networks; and at a radio access network, a UE priority is preferably looked up in terms of its subscriber profile identity signaled from a core network. Load information from various cells is preferably reported at a lower rate than for active-mode load balancing. The setting of priorities is then preferably considering the load of more than one cell. The centralized SON entity preferably updates the mapping table based on statistical information of, e.g., load on RAT/FRQ (Frequency) cells, number of service-triggered redirections and number of tracking area updates.

The RFSP represents (among other things) the most probable service that will be setup, (this is based on the prediction that historically the user has been using a particular service and this is gathered by the Core Network (CN) nodes. So, the table is basically a mapping of the most probable service to priority list. SON algorithm at the centralized nodes makes this mapping load adaptive in order to achieve load balancing.

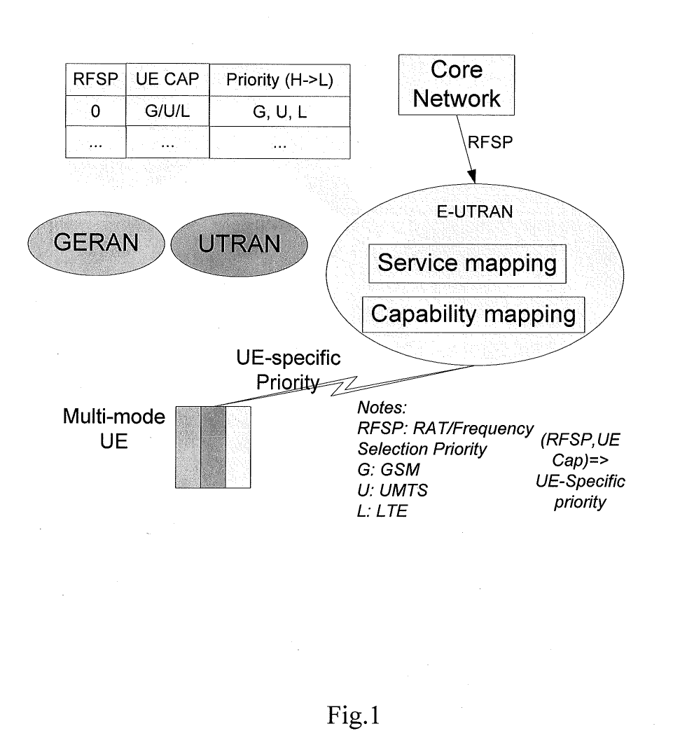

As shown in FIG. 1, E-UTRAN (Evolved Universal Terrestrial Radio Access Network) keeps a mapping table from RFSP and UE CAP (Capability) to priority list. Every time when necessary to assign priority for a UE, E-UTRAN looks up the mapping table using RFSP and UE CAP as an index to get the priority and to configure the UE. A basic embodiment of the method of load balancing in a mobile communications system according to the invention could be described, for a system comprising a plurality of access layers, as comprising the steps:
defining at least one Classifier Index (RFSP) classifying User Equipment (UE) of the mobile communications system,
building a mapping table comprising at least one entry: a Classifier Index mapped to a priority order list for the plurality of access layers,
assigning, to a User Equipment of the mobile communications system, an idle mode priority order of access layers by:
   acquiring the Classifier Index of the User Equipment and assigning the corresponding priority order list from the mapping table to the User Equipment as said idle mode priority order of access layers. The method is distinguished in the following steps of building the mapping table:
      define a network deployment configuration comprising information on each different type of access layer of the plurality of access layers,
      define for the network deployment configuration, a service distribution scheme comprising, for an at least one service of the mobile communications system, an order of preference of the types of the plurality of access layers for the at least one service,
      associate, for the at least one entry of the mapping table, the at least one service with the at least one Classifier Index and set the corresponding priority order list to be the order of preference of the plurality of access layer types defined in the service distribution scheme.

RFSP is a Classifier Index, classifying User Equipment (UE). That is, an index number representing user information, e.g. mobility profile, service usage profile and roaming restrictions. For each subscriber, RFSP is maintained in Core Network (CN) and needs later to be transferred to access network when necessary for idle mode priority control. Access network obtains UE CAP from either CN or UE.

The functionality of the mapping table is to perform service mapping and capability mapping. The mapping can either be a two-step process where service mapping and capability mapping are separate or just a one step process where they are performed together. In the one-step process, the mapping table is an integrated table including two inputs, RFSP and UE capability, while in the two step process, mapping table with only one input RFSP is needed, capability mapping is similar to a filtering process which filters out the unsupported RAT of the UE.

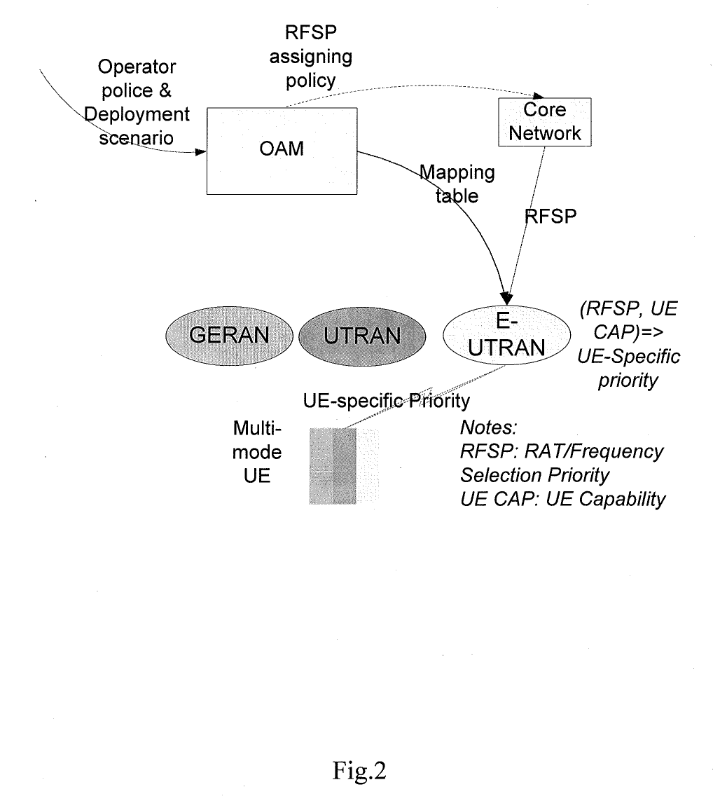

The initial mapping table is built up in an Operations And Maintenance (OAM) node and configured to E-UTRAN as illustrated in FIG. 2. The mapping table is adaptable afterwards for load balancing purposes. Such adaptation could for instance be performed according to a step of the method of load balancing according to the invention:
updating the mapping table by altering at least one entry in relation to at least one load related performance indicator of the mobile communications system. In this way the mapping table can be adapted to a changing load situation.

The principles that OAM is using to build up the table are operator service distribution schemes and network deployment configuration.

Network deployment configuration implies network capability which basically comprises access layer capability and possibly core network capability. Access layers could for instance be of a type from the group consisting of: Radio Access Technology (RAT) network, and frequency band of a Radio Access Technology (RAT) network.

Possible Radio Access Network capabilities are capabilities that support 3GPP RATs such as Global System for Mobile Communications (GSM), Universal Mobile Telecommunications System (UMTS), LTE and Non-3GPP RATs such as Worldwide Interoperability for Microwave Access (WiMAX), Code Division Multiple Access 2000 (CDMA2000) etc.

According to the invention in the step of defining at least one network deployment configuration, we could define said network deployment configuration to also comprise information on capability of a core network of the mobile communications system. As to core network capability, one example is whether a core network supports IP Multimedia Subsystem (IMS) or not, i.e. IMS and non-IMS core. Therefore, it could be further defined, in said method, said capability of a core network to be at least IP Multimedia Subsystem (IMS).

For each particular network deployment configuration, there is one mapping table created for the purpose of priority control.

Based on a particular network deployment configuration, service distribution schemes are needed for building up the mapping table. Each service distribution scheme actually set the traffic steering principles for each service. As an example, Table 1 gives policies for voice, gaming and streaming video under the network deployment configuration: Non-IMS/GSM/LTE.

TABLE 1
Non-IMS/GSM/LTE service policy

| Services | Distribution Policy | Notes |
|---|---|---|
| Voice | Operate in GSM: LTE layer push | |
| | voice to GSM layer; GSM layer | |
| | support Network Assisted Cell | |
| | Change (NACC) to LTE in order for | |
| | Circuit Switched (CS) fallback to | |
| | work. | |
| Gaming | Operate in LTE: LTE layer keep | |
| | gaming service user; GSM push | |
| | gaming subscriber to LTE. | |
| Streaming | Operate in LTE: LTE layer keep | |
| video | stream video user; GSM push stream | |
| | video subscriber to LTE. | |
| . . . | . . . | . . . |

In above table, operator choose operating voice in GSM network where UEs that are most likely to use voice service shall camp on GSM layer and hence set GSM as the top priority in priority list; while for packet service like gaming, streaming video, it is preferred to LTE layer thus set LTE as the highest priority.

With these policies, a mapping table could be established for Non-IMS/GSM/LTE case as shown in Table 2.

TABLE 2
Mapping table for Non-IMS/GSM/LTE

| RFSP | Priority list (High−>Low) | Notes |
|---|---|---|
| 0 (Voice) | (GSM, LTE) | |
| 1 (Gaming) | (LTE, GSM) | |
| 2 (Streaming | (LTE, GSM) | |
| video) | | |
| . . . | . . . | |

RFSP in the table only considers service. In practice however it may comprise some other aspects like Subscriber Class. Thus, according to a step of the method of load balancing according to the invention one would associate, for at least one entry of the mapping table, the Classifier Index (RFSP) additionally with a Subscriber Class, said Subscriber Class discriminating service availability for a subscriber. Thereby, subscribers may be categorized into different classes, each of which is associated with a certain level of mobility/roaming restriction, subscription type etc. For example, define platinum users as without any restrictions, Golden user with few restrictions and normal users with some restrictions. Subscriber Class may also be associated with subscription type, like broadband subscription to be golden user, narrowband subscription to be normal user etc. Therefore according to a step of the method of load balancing according to the invention, said service availability of the Subscriber Class represents any from the group consisting of: number of mobility restrictions, bandwidth availability.

Table 3 shows an example for RFSP taking Subscriber Class into account as well. This categorization undoubtedly influences mobility behavior of UE. The Subscriber Class and service can be encoded together to form RFSP.

TABLE 3
Mapping table for Non-IMS/GSM/LTE

| RFSP | Priority list (High−>Low) | Notes |
|---|---|---|
| 0 (Voice, | (GSM) | |
| normal) | | |
| 1 (voice, | (GSM, LTE) | |
| platinum) | | |
| 2 (Gaming, | (LTE, GSM) | |
| Normal) | | |
| 3 (Streaming | (LTE, GSM) | |
| video, | | |
| Normal) | | |
| . . . | . . . | |

The RFSP encoding algorithm is then transferred to Home Subscriber Server (HSS) to ensure that RFSP is assigned to a subscriber in a coordinated way with OAM. In FIG. 2, RFSP assigning policy is for this purpose.

The distribution policy is set for service by service, in some cases from UE's history, it is possible that multiple services are of almost same possibility of occurrence, hence it is possible to have one RFSP with more than one most probable service. For example, one RFSP with both voice and gaming are most likely to use as exemplified in table 4. Thus, according to the invention we can associate, for at least one entry of the mapping table, the Classifier Index (RFSP) additionally with at least one additional service of the mobile communications system.

In this case, we need a scheme allowing multiple distribution policies to work together.

TABLE 4
Mapping table for Non-IMS/GSM/LTE

| RFSP | Priority list (High−>Low) | Notes |
|---|---|---|
| 0 (Voice, | (GSM) | |
| normal) | | |
| 1 (voice, | (GSM, LTE) | Assume here |
| gaming, | | voice policy |
| platinum) | | prioritize |
| | | over gaming |
| | | policy |
| 2 (Gaming, | (LTE, GSM) | |
| Normal) | | |
| 3 (Streaming | (LTE, GSM) | |
| video, | | |
| Normal) | | |
| . . . | . . . | |

Hence, it is proposed that policy priority is introduced to rank from most important to least important; when multiple policies act simultaneously, the highest priority policy is used.

In some scenarios, operator would like to distribute one service to more than one layer, for example, in IMS/GSM/UMTS/LTE voice can be actually serviced through any of the three RATs. Then a fractional distribution principle could be set for a certain service. In order to accomplish that, the method of the invention could further comprise a step of associating, for at least one entry of the mapping table, at least one additional priority order list, and for each priority order list assigned to the at least one entry, information on the fraction of UEs, having the Classifier Index of that at least one entry, which should use that specific priority order list.

More specifically, fractional distribution can be used for a certain RFSP as shown in Table 5 where 60% of UEs with RFSP 0 (most probable service is voice) will prefer to GSM in camping, 20% of them to UMTS and 20% of them to LTE.

TABLE 5
Fractional distribution for IMS/GSM/UMTS/LTE

| RFSP | Priority list (High−>Low) | Fraction |
|---|---|---|
| 0 (Voice) | (GSM, UMTS, LTE) | 60% |
| 0 (voice) | (UMTS, GSM, LTE) | 20% |
| 0 (voice) | (LTE, GSM, UMTS) | 20% |
| 1 (Gaming) | (LTE, UMTS, GSM) | 100% |
| 2 (Streaming | (LTE, UMTS, GSM) | 100% |
| video) | | |
| . . . | . . . | . . . |

When performing the actual priority assigning to a UE, the entity doing the assigning, e.g. a network access node, has to take into account also the fraction information, as shown in table 5. That is, the method of load balancing according to the invention has to, in the step of assigning to a User Equipment of the mobile communications system an idle mode priority order of access layers, acquire the Classifier Index of the User Equipment and assign, in accordance with the information on the fraction of UEs to use a list, one of the corresponding priority order lists from the mapping table, to the User Equipment as the idle mode priority order of access layers.

As mentioned earlier, capability mapping is either separated from or integrated into service mapping. Correspondingly, mapping table is different. In case of separation, the mapping table performs service mapping only. Capability mapping follows the service mapping without need of mapping table. Here, the capability mapping only considered UE capability because network capability actually has already been taken into account in service mapping. Capability mapping is just a process adapting priority list looked up in the mapping table to UE capability.

In case of one-step process, UE capability is integrated into the mapping table as well. That is, according to the invention at least one entry of the mapping table is associated with at least one UE Capability, which UE Capability defines an ability of a User Equipment (UE) to use an access layer.

Table 6 shows an example for IMS/GSM/UMTS/LTE scenario.

TABLE 6
Capability mapping table for IMS/GSM/UMTS/LTE

| | | Priority list | |
|---|---|---|---|
| RFSP | UE Capability | (High−>Low) | Notes |
| 0 (Voice) | GSM/UMTS/LTE | (GSM, UMTS, LTE) | |
| 0 (voice) | GSM/LTE | (GSM, LTE) | |
| 0 (voice) | UMTS/LTE | (LTE, UMTS) | |
| . . . | . . . | . . . | |

As seen in Table 6, for the method of load balancing, at least one UE Capability can be the ability to use any access layer from the group consisting of: GSM, UMTS, LTE. However, other layer types are conceivable, as well as different frequency bands within a RAT.

In this case, when performing the actual priority assigning to a UE, the entity doing the assigning, e.g. a network access node, has to take into account also UE Capability, as shown in table 6. That is, the method of load balancing according to the invention has to, in the step of assigning to a User Equipment of the mobile communications system an idle mode priority order of access layers, acquire the Classifier Index and the UE Capability of the User Equipment and assign the corresponding priority order list from the mapping table, to the User Equipment as the idle mode priority order of access layers.

In the above table, a very simple example of UE capability is used, where each possible terminal type is represented. It may however be necessary to take into account more specific UE capabilities. But this requires a flexible way of defining the UE capability to avoid that the mapping table becomes too large.

Each entry on the UE capability can further be broken down into different classes which we in this invention call UE Capability class. Thus, in the method of load balancing according to the invention, we would further associate with at least one entry of the mapping table, at least one UE Capability Class, which UE Capability Class defines, for a User Equipment (UE) having a UE Capability, a further ability in usage of an access layer. This solution allows for a flexible definition of UE capability classes where each class can be represented in the mapping table.

According to the invention the at least one UE Capability Class could for instance be the ability to use any access layer feature from the group consisting of: Enhanced Data rates for GSM Evolution (EDGE), High Speed Packet Access (HSPA), HSPA+, Multiple-Input and Multiple-Output (MIMO), high order modulation.

For example, UMTS capable UEs may further be categorized as High Speed Packet Access+ (HSPA+) capable UEs and non-HSPA+ capable UEs, which can be handled discriminately in practice. This is very useful to distribute UEs that favor special service like gaming which is able to operate on both HSPA+ and LTE. HSPA+ capable UE can be distributed to both UMTS and LTE while non-HSPA+ capable UE may only be distributed to LTE for gaming service.

TABLE 7
Capability mapping table with UE capability class

| | UE Capability: | Priority list | |
|---|---|---|---|
| RFSP | UE CAP Class | (High−>Low) | Fraction |
| 1 (Gaming) | GSM/UMTS/LTE: | (UMTS, LTE, GSM) | 60% |
| | HSPA + capable | | |
| 1 (Gaming) | GSM/UMTS/LTE: | (LTE, UMTS, GSM) | 40% |
| | HSPA + capable | | |
| 1 (Gaming) | GSM/UMTS/LTE: | (LTE, UMTS, GSM) | 100% |
| | HSPA + incapable | | |
| . . . | . . . | . . . | |

UE capability class is defined for each capability mode (uni-/Bi-/Tri-mode) by OAM by specifying a more detailed feature of network under one RAT that UE support. This feature is of course able to support certain services. Like HSPA+ to support gaming service shown in above table. Therefore, when UE capability class is defined, OAM need to take network capability and service association into account.

A further attempt to reduce the size of the table is to allow the RFSP and UE capability class to be defined as a range (for example x-y) instead of single values. Another possibility is to also allow a sequence of values (for example x,y). This is illustrated in Table 6.

TABLE 6
Mapping table with ranges and sequences

| | UE Capability: | Priority list | |
|---|---|---|---|
| RFSP | UE CAP Class | (High−>Low) | Fraction |
| 1 | 1-3 | (UMTS, LTE, GSM) | 100% |
| 2-4 | 1, 3 | (LTE, UMTS, GSM) | 100% |
| 2-4 | 2 | (LTE, UMTS, GSM) | 100% |

Thus, according to the method of load balancing according to the invention at least one of Classifier Index and UE Capability Class is represented in the mapping table as a range of values.

In order to implement a method step for assigning to a User Equipment of the mobile communications system an idle mode priority order of access layers taking into account UE Capability class, it is proposed to acquire the Classifier Index and the UE Capability Class of the User Equipment and assigning the corresponding priority order list from the mapping table, to the User Equipment as said idle mode priority order of access layers. This assigning is preferably done by an access network node in the mobile communications system.

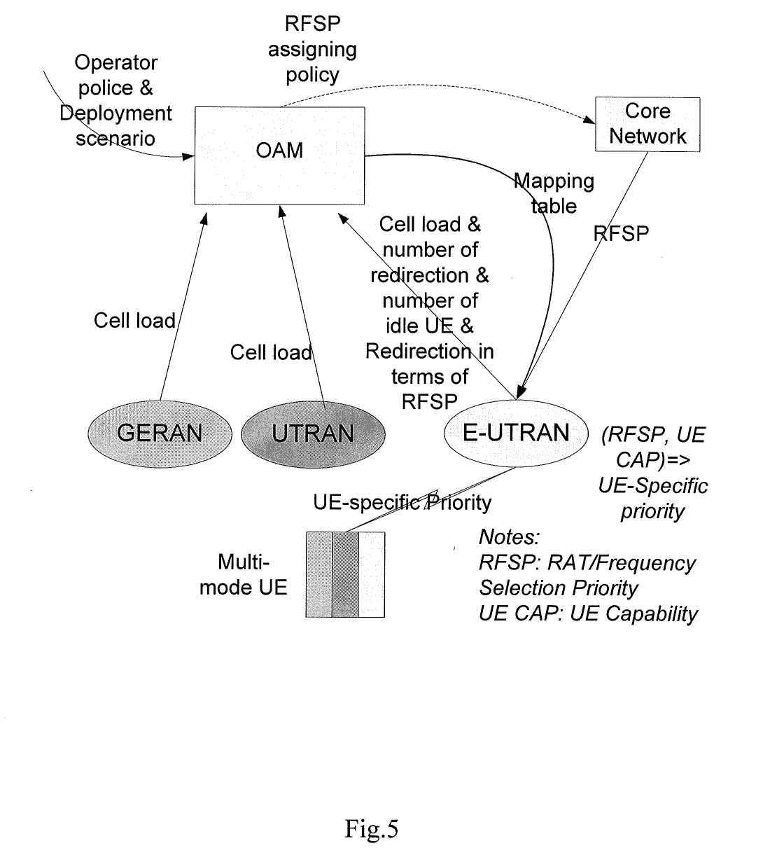

The description above assumes that the mapping table is initially built up and subsequently updated with different load situation at OAM and configured to Access network for local mapping. This is a typical approach of using the mapping table to control priority for load balancing where information between OAM and access network are load-related performance indicator and the mapping table as shown in FIG. 5.

Another approach is that OAM initially configures a set of mapping tables to access network, each of which represents a mapping on a certain load pattern and is associated with a unique table ID. In this case the method of load balancing according to the invention would further comprise to configure at least two different mapping tables and assigning a different Mapping Table ID to each.

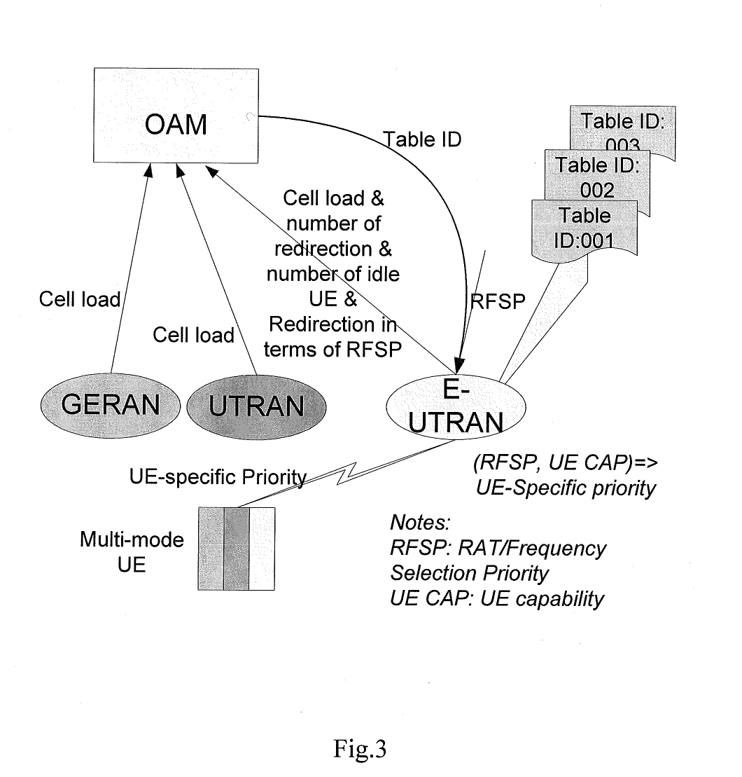

OAM signals access network a table ID showing which mapping table it shall use. Whenever OAM, based on its analysis of load-related performance indicator, find necessity of change of mapping table, it reconfigures the corresponding table ID to access network. That is to say, that according to the method of the invention, in response to a change of a load of the mobile communications system a new mapping table could be assigned by signaling from a central node of the mobile communications system, the corresponding mapping table ID to an access network node of the mobile communications system. This approach is very useful to save the signaling between OAM and access network node in the case that the size of the mapping table is considerably large. FIG. 3 shows an example of this approach.

In the approach illustrated in FIG. 3, the decision-maker on which table shall be used is OAM. In some cases, it is very useful to have access network to make this decision. For example, in a simplified case where unbalanced situation only take local performance indicator into account, e.g. redirection number, idle mode UE number etc., access network is capable of selecting the mapping table based on its analysis of local performance indicator.

Thus, according to the method of load balancing according to the invention, there could be a further step comprising, in response to a change of load of the mobile communications system:
using, in an access network node of the mobile communications system, a new mapping table and notify a central node of the mobile communications system of the use of the new mapping table by signaling the corresponding mapping table ID to the central node.

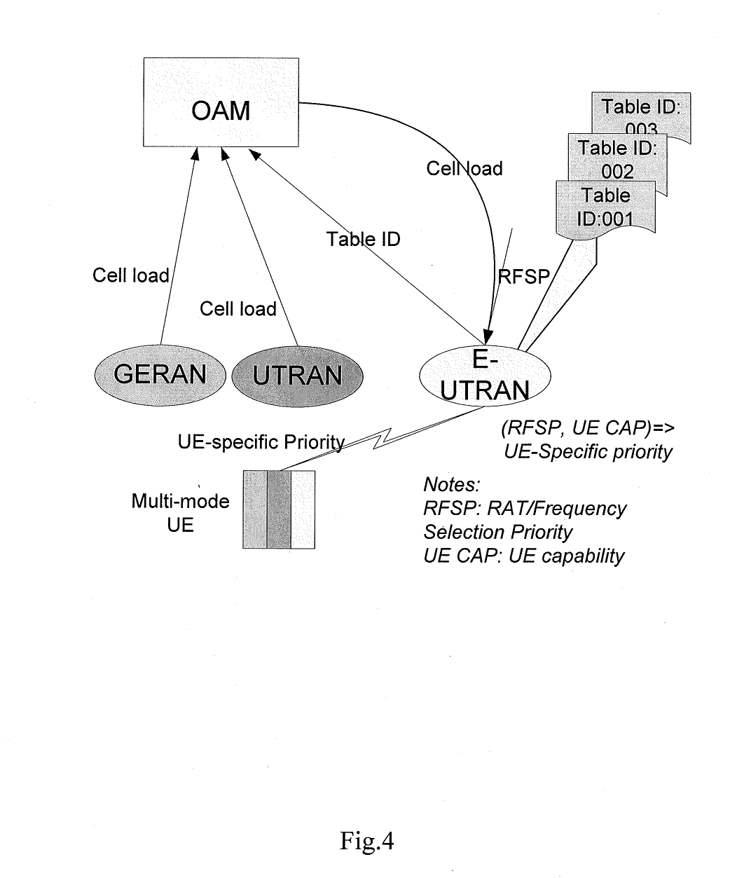

As shown in FIG. 4, in this approach, OAM initially configures a set of mapping tables and associated parameters that shall be used for selecting this table to access network. Access network subsequently decide which mapping table shall be used based on its analysis of local load-related performance indicators. Each time the mapping table changes, access network may notify corresponding table ID to OAM.

In the method relating to this it is conceivable to further signal information on a change of load of another Radio Access Technology network to the access network. I.e., in order to further consider the case that cell load join the mapping table selection, cell load statistics of other RATs can be transferred to access network in concern. So in FIG. 4, signaling of cell load from OAM to E-UTRAN is kept, otherwise, it is not needed.

The initial mapping table is configured to E-UTRAN and can be updated subsequently when needed. The purpose of mapping table update is to balance load of layers. The first step of mapping table update is detection of unequal traffic of different layers, which in this invention relies on load related performance indicator from access network. OAM collects these performance indicators and evaluate these indicators to decide whether the mapping table update is needed or not. If needed, for example when overload is happening on a RAT layer, OAM will adapt the mapping table according to its algorithm.

Load information is one of the most important indicators used to detect unbalance situation. Load information is reported from various access networks, e.g. GERAN, UTRAN, E-UTRAN as shown in FIG. 5, on per cell basis, OAM has the freedom of evaluating them on the granularity of cell, tracking area etc. Each RAT layer is assigned a pre-defined threshold, if the load is above the threshold, overload is regarded happening. So, the load related performance indicator according to the invention can be load information from any access network from the group consisting of GSM EDGE Radio Access Network (GERAN), UTRAN, E-UTRAN.

Yet another indicator, number of service-caused redirection to/from E-UTRAN, can be used to detect unbalanced situation. Over-threshold number of the redirection to E-UTRAN shows that too many UEs that should have camped on E-UTRAN mismatch their best camping layer. Then in this case E-UTRAN layer's priority shall be lift up to pull these UEs in. On the other hand, if number of redirection from E-UTRAN to other RATs is above a threshold, the priority of E-UTRAN layer needs to reduce down. Number of idle mode UE can also be such an indicator. This indicator can be used to avoid unbalanced number of UE camping even though no overload occurs yet. A variant of this indicator is number of periodic Traffic Area Updates (TAU).

Another indicator that this invention proposes is load statistics in terms of RFSP of day allowing for traffic mode adaptive mapping table update as will be described in detail later in this application.

To summarize the examples above, the load related performance indicator according to the method of the invention could for instance be any from the group consisting of: number of redirects to or from a radio access network, number of idle mode UEs in a radio access network, number of periodic Traffic Area Updates (TAU) and load statistics in terms of Classifier Index.

RFSP is assigned by CN to distinguish the service history of a UE. It is possible to collect information about how the different RFSP move in the network when they have transited to active mode. If we collect information about which RFSPs are handed over to other systems, and which RFSPs typically stays in the LTE system, it is possible to evaluate if the current strategy is valid or if one RFSP for example has the highest priority set for LTE, but very often is moved to UMTS when entering active mode.

It is also possible to detect cases where the current RFSP assignment in the CN is not giving enough information, for example if 50% of the UE with the same RFSP stays in LTE and the rest is moved to GSM. Then the system can realize that this RFSP is not providing any helpful information and may need to be reconfigured.

If the mapping tables are updated in a central node (centralized architecture) there is no need to coordinate actions between different nodes. If, on the other hand, the decision to change mapping table is decided in the eNB (distributed architecture) there is a need to coordinate the decisions. One way of doing this is to create a policy controlling how to adjust the mapping tables.

For each performance indicator mentioned above, a certain mapping table update policy is needed. As an example, Table 7 shows a set of update policies where load situation, redirection and idle mode UE camping are considered.

TABLE 7
Mapping table update policy

| Performance | | |
|---|---|---|
| indicator | Mapping table update policy | Notes |
| Load indicator | When load of certain RAT is | |
| | above a pre-defined threshold, | |
| | this RAT is put on the lowest | |
| | priority. | |
| Number of | When number of service caused | |
| redirection | redirection to/from a layer | |
| | (RAT/FRQ) is above a pre- | |
| | defined threshold, adjust | |
| | priority of this layer one | |
| | level of up/down | |
| Number of idle | When number of idle UE camp on | |
| UE | this layer reaches above a | |
| | pre-defined threshold, | |
| | priority of this layer is | |
| | adjust one level down. | |
| . . . | . . . | . . . |

In other words, the method of load balancing according to the invention could further comprise any of the following steps:
set, as a mapping table update policy, the priority of an access layer to lowest in a priority order list of at least one entry of the mapping table when load of this access layer is above a threshold.
set, as a mapping table update policy, the priority of an access layer one level up in a priority order list of at least one entry of the mapping table when number of redirections to the layer is above a threshold.
set, as a mapping table update policy, the priority of an access layer one level down in a priority order list of at least one entry of the mapping table when number of redirections from the layer is above a threshold.
set, as a mapping table update policy, the priority of an access layer one level up in a priority order list of at least one entry of the mapping table when number of idle UEs camping on the access layer is above a threshold.

In order for all the update policies to be able to work together, a method is needed to ensure that they do not interact negatively with each other. It is proposed in this invention that each update policy is associated with one priority. When multiple policies work together, the highest priority update policy is used. For example, in Table 7, we may set update policy due to load indicator the highest priority, when one layer is overloaded, even though according to redirection policy its priority should be increased, we still put it on the lowest priority. That is, in the method of load balancing according to the invention we would further be able to prioritize a mapping table update policy such that when two or more policies are true only the one with highest priority is performed.

In some network deployment configurations, the traffic load mode is regularly changed. For example, in the office area, traffic load is high in the daytime but low during the night. The mapping table may be set differently during the day and night.

In order to detect traffic model, some indicator is needed. One indicator proposed in this invention is traffic load in terms of RFSP where total load is the sum of weighted number of RFSPs. Each type of RFSP number is weighted by a weight factor which represent averaged load of each one of this RFSP. i.e.

Total Load=NO_RFSP1*W_RFSP1+NO_RFSP2*W_RFSP2+ . . .

Based on observation of this indicator, the network is able to know the traffic change model, and accordingly correlate the percentage of RFSPx and the number of idle mode mobiles in a cell based on the time of day and decide, based on priority of RFSPx, where to push mobiles and which policies to apply.

Hence, in the method of load balancing according to the invention we define, as mentioned above, a total load measure as

Total Load==NO_RFSP1*W_RFSP1+NO_RFSP2*W_RFSP2+ . . . +NO_RFSPx*W_RFSPx,

where NO_RFSPx denotes number of User Equipments in an access layer having a Classifier Index RFSPx and W_RFSPx denotes an average load of all User Equipments having a Classifier Index RFSPx in the access layer.

A specific use of the method of load balancing according to the previous paragraph could be to report a Total Load measure to a central node of the mobile communications system. This would be useful in the case where the central node, for instance an OAM node, is the decision-maker on when to use an updated mapping table due to the variation of the Total Load.

According to the method, then, we would change mapping table in regard of a threshold for a Total Load measure, in order to adapt to the change of load information according to the Total Load Measure. The mapping table change could be initiated in the access network or, as in the previous paragraph, in a central node of the mobile communications system, such as an OAM node.

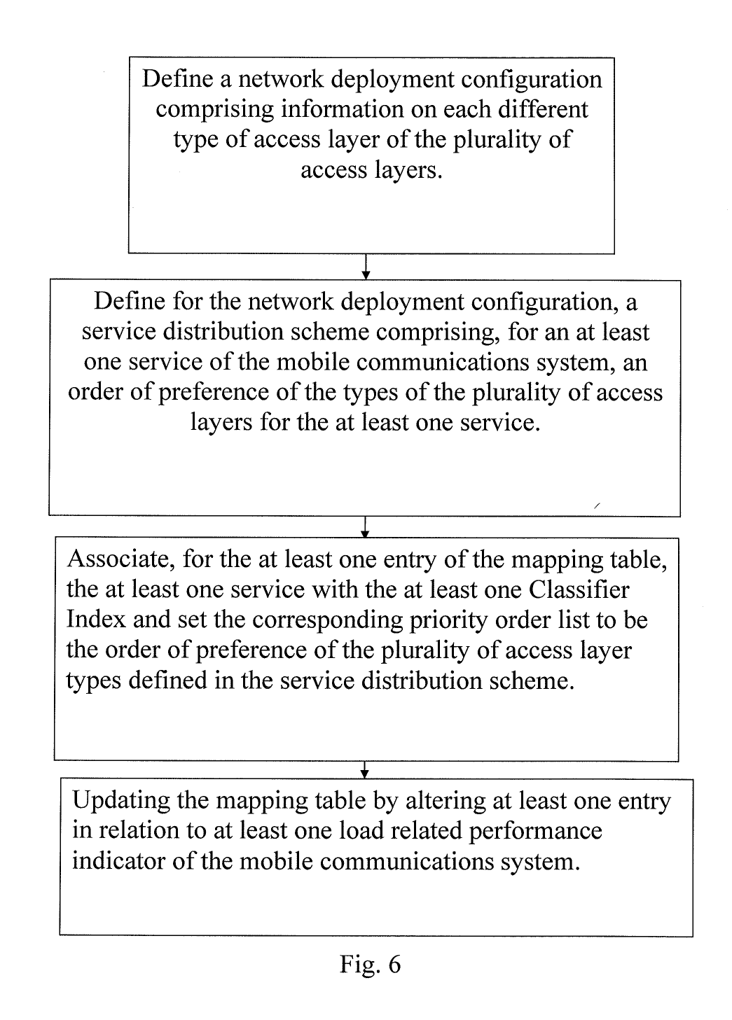

FIG. 6 illustrates steps of a method of load balancing in a mobile communications system according to the invention, the mobile communications system comprising a plurality of access layers. In the uppermost step, it is defined a network deployment configuration comprising information on each different type of access layer of the plurality of access layers.

In a second uppermost step of the method, it is defined for the network deployment configuration, a service distribution scheme comprising, for an at least one service of the mobile communications system, an order of preference of the types of the plurality of access layers for the at least one service.

In a third uppermost step of the method, the at least one service is associated, for at least one entry of a mapping table, with at least one Classifier Index, in the mapping table, and a to the Classifier index corresponding priority order list is set to be the order of preference of the plurality of access layer types defined in the service distribution scheme. Together, the Classifier Index mapped to the priority order list forms the entry of the mapping table.

As is shown in the bottom step of FIG. 6, the mapping table can be updated in relation to at least one load related performance indicator of the mobile communications system by altering at least one entry of the same.

The method of the invention can implemented by a computer program, having code means, which when run in a computer causes the computer to execute the steps of the method. The computer program is included in a computer readable medium of a computer program product. The computer readable medium may consist of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

The different steps of the method of the invention described in this application can be combined or performed in any suitable order. A condition for this is, of course, that the requirements of a step, to be used in conjunction with another step of the method of the invention, in terms of, for instance, Classifier Index, Subscriber Class, number of priority order lists, UE Capability Class, etc. must be fulfilled. In this context some non-exclusive example characteristics of the invention are as follows:

1. Method of load balancing in a mobile communications system comprising a plurality of access layers, the method comprising the steps:

defining at least one Classifier Index (RFSP) classifying User Equipment (UE) of the mobile communications system,

building a mapping table comprising at least one entry: a Classifier Index mapped to a priority order list for the plurality of access layers,

assigning, to a User Equipment of the mobile communications system, an idle mode priority order of access layers by: acquiring the Classifier Index of the User Equipment and assigning the corresponding priority order list from the mapping table to the User Equipment as said idle mode priority order of access layers, comprising the following steps of building the mapping table:

define a network deployment configuration comprising information on each different type of access layer of the plurality of access layers,

define for the network deployment configuration, a service distribution scheme comprising, for an at least one service of the mobile communications system, an order of preference of the types of the plurality of access layers for the at least one service,

associate, for the at least one entry of the mapping table, the at least one service with the at least one Classifier Index and set the corresponding priority order list to be the order of preference of the plurality of access layer types defined in the service distribution scheme.

2. Method of load balancing according to characteristic 1, comprising the step:

updating the mapping table by altering at least one entry in relation to at least one load related performance indicator of the mobile communications system.

3. Method of load balancing according to characteristic 1, wherein the access layers of the plurality of access layers are of any type from the group consisting of: Radio Access Technology (RAT) network, and frequency band of a Radio Access Technology (RAT) network.
4. Method of load balancing according to characteristic 3, wherein the Radio Access Technology (RAT) network is any from the group consisting of: GSM, UMTS, LTE, WiMAX, CDMA2000.
5. Method of load balancing according to characteristic 1, wherein in the step of defining at least one network deployment configuration, define said network deployment configuration to also comprising information on capability of a core network of the mobile communications system.
6. Method of load balancing according to characteristic 5, wherein further defining said capability of a core network to be at least IP Multimedia Subsystem (IMS).
7. Method of load balancing according to characteristic 1, further comprising:

associate, for at least one entry of the mapping table, the Classifier Index (RFSP) additionally with a Subscriber Class, said Subscriber Class discriminating service availability for a subscriber.

8. Method of load balancing according to characteristic 7, wherein said service availability of the Subscriber Class represents any from the group consisting of: number of mobility restrictions, bandwidth availability.
9. Method of load balancing according to characteristic 1, further comprising:

associate, for at least one entry of the mapping table, the Classifier Index (RFSP) additionally with at least one additional service of the mobile communications system.

10. Method of load balancing according to characteristic 1, further comprising:

associate, for at least one entry of the mapping table, at least one additional priority order list, and for each priority order list assigned to the at least one entry, information on the fraction of UEs, having the Classifier Index of that at least one entry, which should use that specific priority order list.

11. Method of load balancing according to characteristic 10, wherein in the step of assigning to a User Equipment of the mobile communications system an idle mode priority order of access layers,

acquiring the Classifier Index of the User Equipment and assigning, in accordance with the information on the fraction of UEs to use a list, one of the corresponding priority order lists from the mapping table, to the User Equipment as said idle mode priority order of access layers.

12. Method of load balancing according to characteristic 1, further comprising:

associate with at least one entry of the mapping table, at least one UE Capability, which UE Capability defines an ability of a User Equipment (UE) to use an access layer.

13. Method of load balancing according to characteristic 12, wherein the at least one UE Capability is the ability to use any access layer from the group consisting of: GSM, UMTS, LTE.
14. Method of load balancing according to any of characteristics 12-13, wherein in the step of assigning to a User Equipment of the mobile communications system an idle mode priority order of access layers,

acquiring the Classifier Index and the UE Capability of the User Equipment and assigning the corresponding priority order list from the mapping table, to the User Equipment as said idle mode priority order of access layers.

15. Method of load balancing according to characteristic 13, further comprising:

associate with at least one entry of the mapping table, at least one UE Capability Class, which UE Capability Class defines, for a User Equipment (UE) having a UE Capability, a further ability in usage of an access layer.

16. Method of load balancing according to characteristic 15, wherein
at least one of Classifier Index and UE Capability Class is represented in the mapping table as a range of values.
17. Method of load balancing according to any of characteristics 15-16, wherein in the step of assigning to a User Equipment of the mobile communications system an idle mode priority order of access layers,

acquiring the Classifier Index and the UE Capability Class of the User Equipment and assigning the corresponding priority order list from the mapping table, to the User Equipment as said idle mode priority order of access layers.

18. Method of load balancing according to characteristic 1, further comprising:

configuring at least two different mapping tables and assigning a different Mapping Table ID to each.

19. Method of load balancing according to characteristic 18, further comprising, in response to a change of a load of the mobile communications system:

assign a new mapping table by signaling from a central node of the mobile communications system, the corresponding mapping table ID to an access network node of the mobile communications system.

20. Method of load balancing according to characteristic 18, further comprising, in response to a change of load of the mobile communications system:

using, in an access network node of the mobile communications system, a new mapping table and notify a central node of the mobile communications system of the use of the new mapping table by signaling the corresponding mapping table ID to the central node.

21. Method of load balancing according to characteristic 20, further comprising,

signaling information on a change of load of another Radio Access Technology network to the access network.

22. Method of load balancing according to characteristic 2, wherein the load related performance indicator being load information from any access network from the group consisting of GERAN, UTRAN, E-UTRAN.
23. Method of load balancing according to characteristic 2, wherein the load related performance indicator being any from the group consisting of: number of redirects to or from a radio access network, number of idle mode UEs in a radio access network, number of periodic Traffic Area Updates (TAU) and load statistics in terms of Classifier Index.
24. Method of load balancing according to characteristic 22, further comprising,

set, as a mapping table update policy, the priority of an access layer to lowest in a priority order list of at least one entry of the mapping table when load of this access layer is above a threshold.

25. Method of load balancing according to characteristic 24, further comprising,

set, as a mapping table update policy, the priority of an access layer one level up in a priority order list of at least one entry of the mapping table when number of redirections to the layer is above a threshold.

26. Method of load balancing according to characteristic 24, further comprising,

set, as a mapping table update policy, the priority of an access layer one level down in a priority order list of at least one entry of the mapping table when number of redirections from the layer is above a threshold.

27 Method of load balancing according to characteristic 24, further comprising,

set, as a mapping table update policy, the priority of an access layer one level up in a priority order list of at least one entry of the mapping table when number of idle UEs camping on the access layer is above a threshold.

28. Method of load balancing according to any of characteristics 24-27, further comprising,

prioritize a mapping table update policy such that when two or more policies are true only perform the one with highest priority.

29. Method of load balancing according to characteristic 1, further comprising

define a total load measure as Total Load=NO_RFSP1*W_RFSP1+NO_RFSP2*W_RFSP2+ . . . +NO_RFSPx*W_RFSPx, wherein NO_RFSPx denotes number of User Equipments in an access layer having a Classifier Index RFSPx and W_RFSPx denotes an average load of all User Equipments having a Classifier Index RFSPx in the access layer.

30. Method of load balancing according to characteristic 29, further comprising

report a Total Load measure to a central node of the mobile communications system.

31. Method of load balancing according to any of characteristics 29-30, further comprising

change mapping table in regard of a threshold for a Total Load measure.

32. Computer program product, comprising code means, which when run in a computer causes the computer to execute the method according to any of the characteristics 1-32.
33. Computer program product according to characteristic 32 comprising a computer readable medium.
34. Computer program product according to characteristic 33, wherein said computer readable medium consists of one or more from the group: ROM (Read-Only Memory), PROM (Programmable Read-Only Memory), EPROM (Erasable PROM), Flash memory, EEPROM (Electrically Erasable PROM), hard disk drive.

In this description, certain acronyms and concepts widely adopted within the technical field have been applied in order to facilitate understanding. The invention is not limited to units or devices due to being provided particular names or labels. It applies to all methods and devices operating correspondingly. This also holds in relation to the various systems that the acronyms might be associated with.

While the invention has been described in connection with specific embodiments thereof, it will be understood that it is capable of combining the various embodiments, or features thereof, as well as of further modifications. This specification is intended to cover any variations, uses, adaptations or implementations of the invention; not excluding software enabled units and devices, processing in different sequential order where non-critical, or mutually non-exclusive combinations of features or embodiments; within the scope of subsequent characteristics following, in general, the principles of the invention as would be obvious to a person skilled in the art to which the invention pertains.

1. A method of load balancing in a mobile communications system comprising a central network node, and at least one access network node, of the mobile communications system comprising
dynamically setting circuitry providing a representation of a mapping table for mapping data to a User Equipment (UE) priority list,
wherein the UE priority list comprises respective priorities of two or more access layers, and
wherein the access layers comprises at least one of
a frequency access layer, and
a RAT access layer.

2. The method according to claim 1, wherein at least a relevant part of the representation of the mapping table is communicated from the central network node to at least one of the at least one access network node.

3. The method according to claim 2, wherein the central network node comprises OAM and the particular representation of mapping table to apply is determined by OAM.

4. The method according to 2, wherein the at least one of the at least one access network node determines which out of a plurality of mapping tables to use depending on load-related performance indicators.

5. The method according to 2, wherein load related data is received in an access network node over X2 interface.

6. The method according to 2, wherein load related data is provided by an access network node over X2 interface.

7. The method according to 2, wherein the central network node configures a set of representations of a plurality of mapping tables.

8. The method according to claim 1, wherein the representation of the mapping table is determined on the basis of at least one of
load of at least one access network node,
number of idle-mode UE devices of a particular RAN,
number of service-caused redirections to/from E-UTRAN,
number of traffic area updates, TAUs, and
load statistics.

9. The method according to claim 1, wherein an input to the circuitry setting the representation of the mapping table comprises a classifier index representing UE classification comprising at least one of
mobility profile,
service usage profile,
subscription type,
bandwidth, and
roaming restrictions.

10. The method according to claim 1, wherein an input to the circuitry setting the representation of the mapping table comprises a classifier index representing UE capability comprising at least one of
EDGE capability,
HSPA capability,
HSPA+ capability,
MIMO capability, and
LTE capability.

11. The method according to claim 1, wherein an input to the circuitry setting the representation of the mapping table comprises core network capability.

12. The method according to claim 11, wherein the core network capability input comprises an IMS-core indicator.

13. The method according to claim 1, wherein the setting distinguishes active-mode UE and idle-mode UE setting.

14. The method according to claim 13, wherein input to the setting of idle-mode UE setting is communicated at a lower rate than input to the setting of active-mode UE setting.

15. A network node device of load balancing in a mobile communications system comprising a central network node, and at least one access network node, of the mobile communications system, the network node device comprising
circuitry of dynamically setting a representation of a mapping table for mapping data to a User Equipment (UE) priority list,
wherein the UE priority list comprises respective priorities of two or more access layers, and
wherein the access layers comprises at least one of
a frequency access layer, and
a RAT access layer.

16. The network node according to claim 15, wherein the node is at least one of
a central node,
an HSS, and
an OAM.

17. The network node according to claim 15, comprising
electric interface circuitry of communicating a table identity, identifying the representation of the mapping table in another network node.

18. The network node according to claim 15, comprising
electric interface circuitry of communicating with an access network node.

19. The network node according to claim 18, wherein the electric interface circuitry is interface circuitry instrumenting an X2 interface.

20. The network node according to claim 15, wherein the network node comprises
processing circuitry of determining applicable representation of mapping table.

21. A radio communications system comprising
a network node of dynamically setting a representation of a mapping table for mapping data to a User Equipment (UE) priority list,
wherein the UE priority list comprises respective priorities of two or more access layers, and
wherein the access layers comprises at least one of
a frequency access layer, and
a RAT access layer; and
wherein the network node comprises interface circuitry for exchange of a load information indicator with another network node of the radio communications system.

22. The radio communications system according to claim 21, wherein the interface circuitry is further capable of information exchange of at least one of
UE capability and
Access network capability.
